(19) United States
(12) Patent Application Publication
(10) Pub. No.: US 2025/0059908 A1
(43) Pub. Date: Feb. 20, 2025

(54) SINE ROTARY ENGINE

(71) Applicants: Byeong Woo KIM, Hwaseong-si (KR); Seong Wool KIM, Hwaseong-si (KR)

(72) Inventors: Byeong Woo KIM, Hwaseong-si (KR); Seong Wool KIM, Hwaseong-si (KR)

(21) Appl. No.: 18/934,191

(22) Filed: Oct. 31, 2024

Related U.S. Application Data
(63) Continuation of application No. PCT/KR2023/005912, filed on May 9, 2023.

(30) Foreign Application Priority Data
May 13, 2022 (KR) 10-2022-0058958

(51) Int. Cl. F02B 53/12; F02B 55/02

(52) U.S. Cl. CPC F02B 53/12; F02B 55/02

(57) ABSTRACT

The present invention relates to a sine rotary engine and, more specifically, to a technology providing high torque, thereby minimizing energy loss, by using a machine device, which can be used for various purposes such as for producing power by converting, into rotational energy, energy generated using fluid having various pressures or through a chemical reaction of fuel, and, conversely, for a pump that receives power from the outside so as to transfer fluid.

### TECHNICAL FIELD

The present invention relates to a sine rotary engine, and more particularly to a technique of not only generating power by converting, into rotational energy, energy generated by using fluid having various pressures or obtained through a chemical reaction of fuel, but also maximally reducing energy loss by providing high torque through a mechanical device capable of being used for various purposes, such as a pump configured to receive power from the outside and transport fluid.

### BACKGROUND ART

An apparatus capable of converting various types of energy is used in various fields. Examples of the apparatus include an apparatus capable of converting the pressure from various kinds of fluid, such as steam pressure, air pressure, water pressure, and hydraulic pressure, into kinetic energy or electric energy, and an apparatus capable of converting combustible fuel such as fossil fuel into kinetic energy or electric energy based on a chemical reaction of the combustible fuel.

Particularly, in the case of a generator capable of generating a large amount of electric energy, electric energy is generated by rotating a steam turbine using the pressure of steam generated by vaporizing water using high-temperature heat energy.

However, a conventional steam turbine is configured to be rotated by pushing a plurality of blades thereof, and structurally, all steam pressure may not rotate the turbine blades. That is, there is a problem in that energy loss occurs in the process of rotating the turbine blades.

In order to increase power generation efficiency of a generator, it is preferable to provide high torque at lower RPM to the generator instead of providing high RPM to the generator. Here, a reducer is installed on a power shaft of the generator so as to lower the RPM of the generator. However, installation of the reducer causes various problems such as an increase in weight of the generator, energy loss of the generator, and bearing failure of a rotating shaft.

In addition, high torque is required not only for the generator but also for an internal combustion engine using fuel. It is difficult to obtain desired power simply using high RPM, so it is important to provide an appropriate distribution of torque and RPM to the generator and the internal combustion engine.

### DISCLOSURE

### Technical Problem

Therefore, the present invention has been made in view of the above problems, and it is an object of the present invention to provide, in obtaining electric energy using various types of fluid pressure or implementing a power conversion device using the same, a sine rotary engine configured to maximally reduce energy loss and to provide high torque without excessive RPM, thereby making it possible to address various problems in the related art.

### Technical Solution

In accordance with the present invention, the above and other objects can be accomplished by the provision of a sine rotary engine including a rotor housing having an inlet pipe and an outlet pipe respectively formed therein, the rotor housing having an inner space formed with a curved inner surface of the rotor housing and configured to allow fluid introduced through the inlet pipe to fill the inner space, a power shaft rotatably installed inside the rotor housing, the power shaft being installed at a position eccentric from a central point of the inner space, a reciprocating rotor formed corresponding to a width of the inner space of the rotor housing and installed through a central portion of the power shaft in a radial direction of the power shaft, wherein the reciprocating rotor is rotated inside the rotor housing while performing linear reciprocating motion in the radial direction of the power shaft according to a rotation angle thereof, and an eccentric shaft formed to have a smaller diameter than a diameter of the power shaft and rotatably installed in the rotor housing, wherein the eccentric shaft is connected to a central portion of the reciprocating rotor and guides the reciprocating rotor such that the reciprocating rotor has a constant rotational orbit.

The power shaft may be installed at a lower portion of a center of the rotor housing, and the inlet pipe and the outlet pipe may be respectively formed on a left side and a right side of the power shaft.

A central point of the eccentric shaft may be located above a central point of the power shaft.

The reciprocating rotor may have a first pin hole formed in the central portion thereof, and the eccentric shaft may have a second pin hole formed in a position eccentric from a central portion of the eccentric shaft, wherein the reciprocating rotor and the eccentric shaft may be axially coupled to each other by a guide pin inserted into the first pin hole and the second pin hole.

The inlet pipe may be formed to be smaller than the outlet pipe.

The inlet pipe may be formed of a plurality of inlet pipes including a first inlet pipe and a second inlet pipe, and the outlet pipe may be formed of a plurality of outlet pipes including a first outlet pipe and a second outlet pipe.

The rotor housing may have a first ignition plug and a second ignition plug installed therein, the first ignition plug being disposed between the first inlet pipe and the second inlet pipe, the second ignition plug being disposed between the first outlet pipe and the second outlet pipe, and the first ignition plug and the second ignition plug may cause combustion in the inner space of the rotor housing.

### Advantageous Effects

When a sine rotary engine according to the present invention is used as a device such as a generator configured to generate electric energy by using steam pressure, gas pressure, air pressure, water pressure, and hydraulic pressure, and a pressure difference between fluids, energy loss may be maximally reduced, and high-torque rotational force may be obtained as compared with the related art, thereby making it possible to operate the sine rotary engine under preferable conditions for electricity production.

Furthermore, when the sine rotary engine according to the present invention is used as an internal combustion engine configured to generate power by causing a combustion reaction using fluid and a combustible material such as fossil fuel, high torque may be obtained and energy efficiency may be significantly improved. Furthermore, the sine rotary engine according to the present invention has a configuration in which two strokes are performed in one rotor housing. Accordingly, when two or more sine rotary engines are arranged so as to simultaneously perform four or more strokes, it is possible not only to achieve an efficient structure and weight reduction compared to other engines of the related art, but also to directly rotate a power shaft based on eccentric circular motion without using a connecting rod and a crankshaft of the related art, thereby having an effect of solving torque imbalance.

### DESCRIPTION OF DRAWINGS

The above and other objects, features and other advantages of the present invention will be more clearly understood from the following detailed description taken in conjunction with the accompanying drawings, in which:

FIG. 1 is a cross-sectional view of a main configuration of a sine rotary engine according to the present invention;

FIG. 2 is a side cross-sectional view of the configuration of the sine rotary engine according to the present invention;

FIG. 3 is a view showing an example of the operation of a power shaft and a reciprocating rotor constituting the sine rotary engine according to the present invention;

FIG. 4 is an exploded perspective view of the main configuration of the sine rotary engine according to the present invention, in which the exploded perspective view shows a coupling example of an eccentric shaft in the sine rotary engine;

FIG. 5 is a view showing operation procedures of the sine rotary engine according to the present invention in a sequential manner;

FIG. 6 is a view showing a sine rotary engine according to another embodiment of the present invention;

FIG. 7 is a view showing an example of applying the sine rotary engine according to the present invention to an internal combustion engine;

FIG. 8 is a view sequentially showing changes in stroke operation of the sine rotary engine according to the present invention applied to the internal combustion engine; and

FIG. 9 is a view showing an embodiment in which the power shaft according to the present invention is transformed into a different shape and is applied to the sine rotary engine.

### BEST MODE

Hereinafter, preferred embodiments of the present invention will be described in detail with reference to the attached drawings. In describing the embodiments disclosed herein, when it is determined that a detailed description of publicly known techniques or configurations to which the present invention pertains may obscure the gist of the present invention, detailed description thereof will be omitted.

A sine rotary engine according to the present invention may be used as a device such as a generator configured to generate electric energy by using steam pressure, gas pressure, air pressure, water pressure, and hydraulic pressure, and a pressure difference between fluids. Further, the sine rotary engine may be used as an internal combustion engine configured to generate power by causing a combustion reaction using fluid and a combustible material such as fossil fuel. Additionally, the sine rotary engine may be utilized in various ways as a mechanical device such as a pump configured to receive power from the outside and transport fluid.

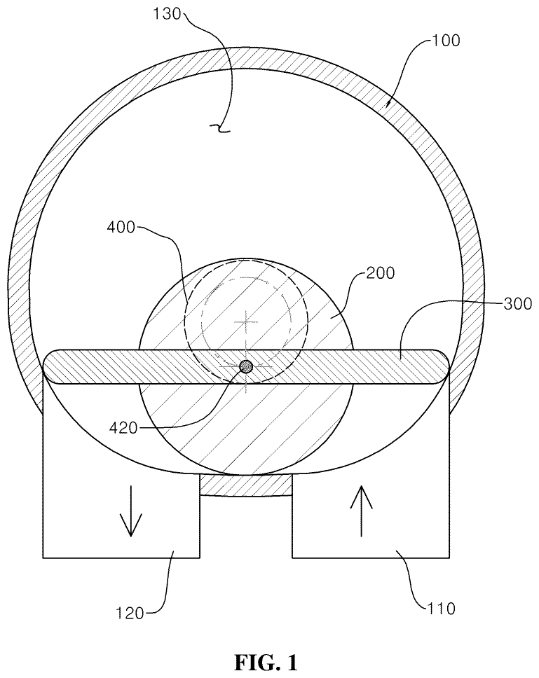

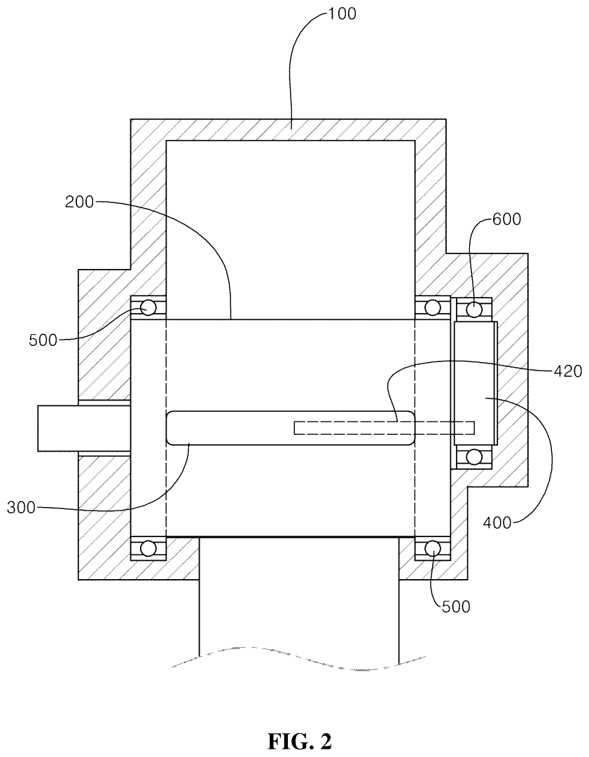

As shown in FIGS. 1 and 2, the sine rotary engine of the present invention includes a rotor housing 100 having an inlet pipe 110 and an outlet pipe 120 respectively formed therein, in which the rotor housing has an inner space 130 formed with a curved inner surface of the rotor housing and configured to allow fluid introduced through the inlet pipe 110 to fill the inner space, a power shaft 200 rotatably installed inside the rotor housing 100, in which the power shaft 200 is installed at a position eccentric from a central point of the inner space 130, a reciprocating rotor 300 formed corresponding to the width of the inner space 130 of the rotor housing 100 and installed through a central portion of the power shaft 200 in the radial direction, in which the reciprocating rotor is rotated inside the rotor housing 100 while performing linear reciprocating motion in the radial direction of the power shaft 200 according to the rotation angle thereof, and an eccentric shaft 400 formed to have a smaller diameter than a diameter of the power shaft 200 and rotatably installed in the rotor housing 100, in which the eccentric shaft is connected to a central portion of the reciprocating rotor 300 and guides the reciprocating rotor 300 such that the reciprocating rotor 300 has a constant rotational orbit.

As shown in FIG. 1, the rotor housing 100 of the present invention has the inner space 130 formed therein and configured to allow the reciprocating rotor 300 to be rotated therein. In this case, although the shape of the inner space 130 appears to be circular in the drawing, the inner space 130 does not have a perfect circular shape. The internal shape of the rotor housing 100 is determined by a ratio of the length of the reciprocating rotor 300 to the diameter of the eccentric shaft 400. That is, as the diameter of the eccentric shaft 400 becomes smaller, the internal shape of the rotor housing 100 is formed to be closer to a circular shape. On the other hand, when the diameter of the eccentric shaft 400 is relatively large, the rotor housing 100 is formed to have a cardioid shape.

Here, the rotor housing 100 is determined by the following Equation.

sin(θ)+k or α cos(θ)+k

Here, α represents the diameter of the eccentric shaft 400 (eccentric circle), k represents half of the length of the reciprocating rotor 300, and 2k is equal to the length of the reciprocating rotor 300. The shape of the rotor housing 100 is determined by a ratio of a to k, and the size of the circle of the eccentric shaft 400 is determined for the shape of each rotor housing 100. Here, θ is an angle from 0 to 2π, which is an angular range for traces of points drawn around an origin according to a value of a polar coordinate equation.

Further, the rotor housing 100 has the inlet pipe 110 and the outlet pipe 120 respectively formed therein. First, the power shaft 200 is installed at a lower portion of the center of the rotor housing 100, and the inlet pipe 110 and the outlet pipe 120 are respectively formed on the left and right sides of the power shaft 200. According to this structural configuration, fluid introduced into the rotor housing 100 makes one rotation inside the rotor housing 100 along the reciprocating rotor 300 and then is discharged from the rotor housing.

As shown in the drawing, the power shaft 200 of the present invention is configured to be rotatably installed inside the rotor housing 100. When used as a power device including a generator, the power shaft is used as a shaft to output power obtained by rotation of the reciprocating rotor 300 to the outside.

The power shaft 200 is installed at a position eccentric from the central point of the rotor housing 100. As described above, the power shaft is installed at the lower portion of the rotor housing 100.

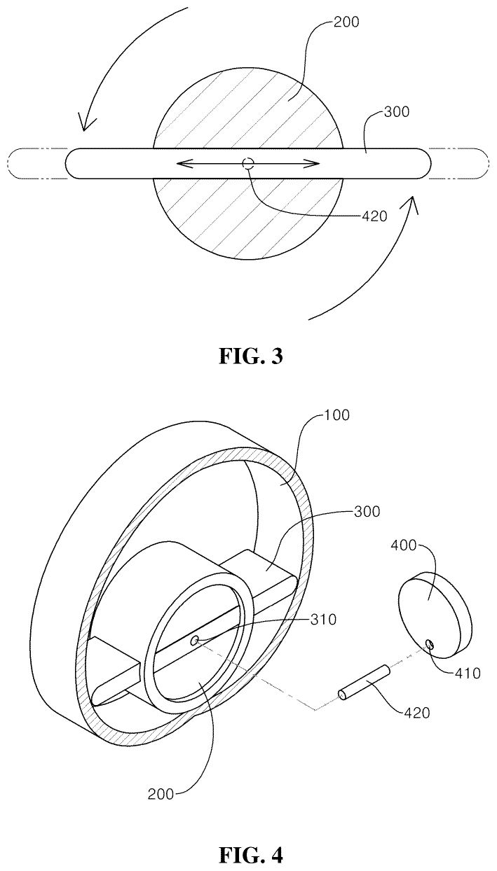

The reciprocating rotor 300 of the present invention is configured to be coupled to the power shaft 200 and to be installed through the center of the power shaft 200 in the radial direction. As shown in FIG. 3, the reciprocating rotor 300 is capable of performing linear motion in the radial direction of the power shaft 200.

The reciprocating rotor 300 is rotated by pressure of the introduced fluid. Here, the reciprocating rotor 300 performs, according to the angle of rotation, linear motion while alternately changing the center of the power shaft 200 left and right. When the linear motion is repeatedly performed in a state in which the reciprocating rotor 300 is continuously rotated in this manner, the reciprocating rotor 300 performs linear reciprocating motion.

The length of the reciprocating rotor 300 is formed corresponding to the width of the inner space 130 of the rotor housing 100. The end of the reciprocating rotor 300 may or may not be in contact with the inner wall of the rotor housing 100. When it is required to increase sealing force, the opposite ends of the reciprocating rotor 300 are preferably configured to be in contact with the inner wall of the rotor housing 100. Meanwhile, when it is required to maximally reduce frictional force, it is preferable to form a fine gap between the opposite ends of the reciprocating rotor 300 and the inner wall of the rotor housing 100.

The eccentric shaft 400 of the present invention is rotatably coupled to the rotor housing 100 and is also coupled to the reciprocating rotor 300 so as to guide the reciprocating rotor 300 such that the reciprocating rotor has a constant rotational orbit. The eccentric shaft 400 is formed to have a smaller diameter than a diameter of the power shaft 200. Further, the eccentric shaft 400 is installed at a position eccentric from a center point of the power shaft 200. That is, a center point of the eccentric shaft 400 is located above the center point of the power shaft 200.

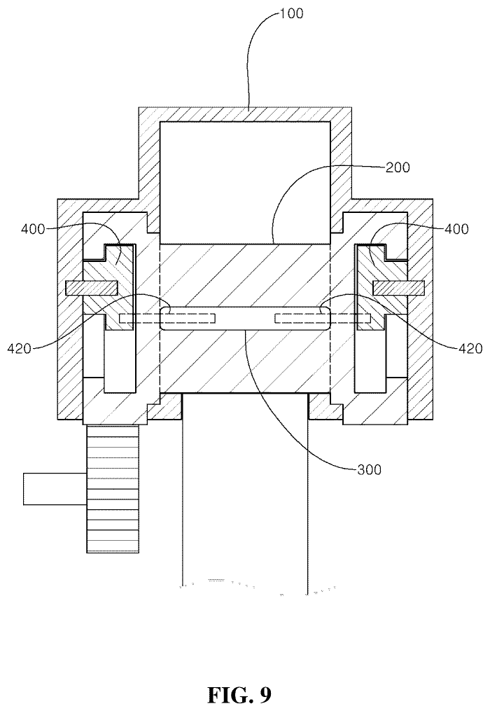

In the coupling structure of the eccentric shaft 400 and the reciprocating rotor 300, as shown in FIG. 4, a first pin hole 310 is formed in a central portion of the reciprocating rotor 300, and a second pin hole 410 is formed in a position eccentric from a central portion of the eccentric shaft 400. Here, the reciprocating rotor and the eccentric shaft are axially coupled to each other by a guide pin 420 inserted into the first pin hole 310 and the second pin hole 410. In this case, as shown in the drawing, the eccentric shaft 400 may be installed on only one side of the rotor housing. Alternatively, the eccentric shafts may be respectively installed on opposite sides of the rotor housing for smoother rotation, as shown in FIG. 9.

Furthermore, the rotor housing 100 preferably has bearings installed therein. Specifically, the bearings are respectively installed in portions of the rotor housing, the portions allowing the power shaft 200 and the eccentric shaft 400 to be respectively installed therein, thereby performing smooth rotational motion. More specifically, as shown in FIG. 2, a first bearing 500 is installed in a portion of the rotor housing, the portion allowing the power shaft 200 to be installed therein, and a second bearing 600 is installed in a portion of the rotor housing, the portion allowing the eccentric shaft 400 to be installed therein. In addition, it is preferable to additionally install a bearing (not shown) in the first pin hole 310 or the second pin hole 410 into which the guide pin 420 is inserted so as to perform smooth rotational motion.

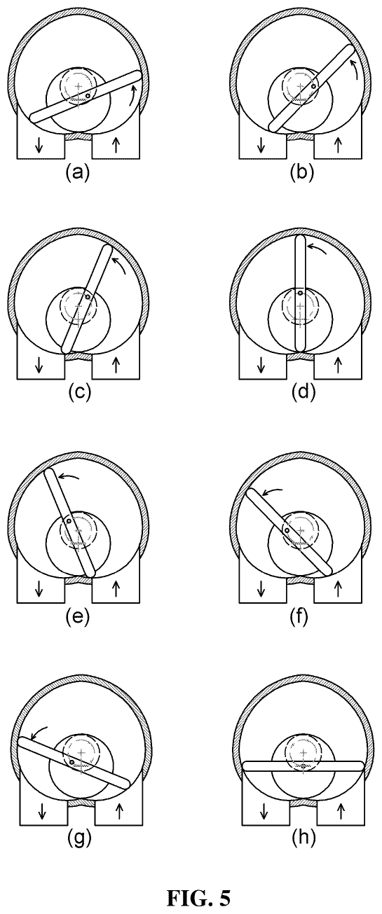

Movement of the reciprocating rotor 300 of the present invention will be described with reference to FIG. 5 as follows. That is, when fluid is introduced from the outside through the inlet pipe 110, the reciprocating rotor 300 is pushed by the pressure of the introduced fluid and is rotated in one direction. In this process, the reciprocating rotor 300 performs linear reciprocating motion in accordance with a rotational orbit of the guide pin 420 coupled to the eccentric shaft 400 and is rotated inside the rotor housing 100 so as to discharge the fluid through the outlet pipe 120. Finally, the reciprocating rotor rotates the power shaft 200 to generate power or rotational energy. In this case, referring to FIG. 5, when the eccentric shaft 400 is rotated 360 degrees, the power shaft 200 is rotated 180 degrees, thereby obtaining a rotation ratio in which the power shaft 200 is rotated once while the eccentric shaft 400 is rotated twice.

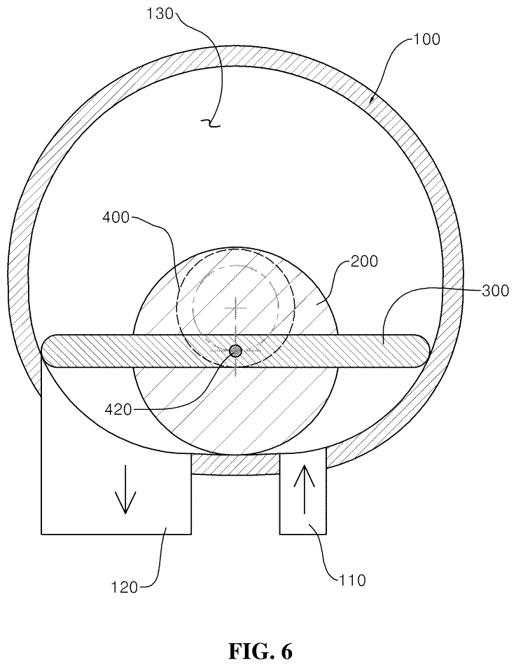

FIG. 6 is a view showing a sine rotary engine according to another embodiment of the present invention. Here, the inlet pipe 110 may be formed to be smaller than the outlet pipe 120. As in the embodiment of FIG. 1, in the case of a structural configuration in which the sizes of the inlet pipe 110 and the outlet pipe 120 are the same, it is preferable to apply fluid in the liquid state such as hydraulic pressure or water pressure to this structural configuration. Meanwhile, as shown in FIG. 6, in the case of a structural configuration in which the inlet pipe 110 is formed to be smaller than the outlet pipe 120, it is preferable to apply fluid in the gaseous state such as vapor pressure or air pressure to this structural configuration.

Although the operation methods of the structural configurations shown in FIGS. 1 and 6 are the same, there is a difference therebetween in that, when the size of the inlet pipe 110 is adjusted to be smaller than that of the outlet pipe 120, the rotation angle of the reciprocating rotor 300 until a suction pipe is completely opened and closed, the rotation angle of the reciprocating rotor when introduction and discharge of fluid do not occur, the rotation angle of the reciprocating rotor when fluid is discharged through the outlet pipe 120, and the rotation angle of the reciprocating rotor when fluid is completely discharged from the outlet pipe are changed.

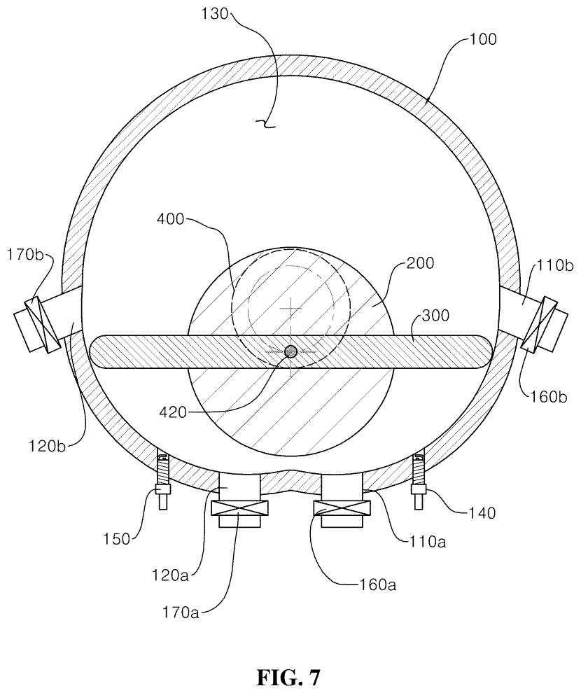

FIG. 7 is a view showing a sine rotary engine according to another embodiment of the present invention. In this embodiment, the inlet pipe 110 is formed of a plurality of inlet pipes including a first inlet pipe 110a and a second inlet pipe 110b, and the outlet pipe 120 is formed of a plurality of outlet pipes including a first outlet pipe 120a and a second outlet pipe 120b.

FIG. 7 is a view showing an example of applying the sine rotary engine according to the present invention to an internal combustion engine. The rotor housing 100 has a first ignition plug 140 installed therein, in which the first ignition plug is disposed between the first inlet pipe 110a and the second inlet pipe 110b. Furthermore, the rotor housing 100 has a second ignition plug (150) installed therein, in which the second ignition plug is disposed between the first outlet pipe 120a and the second outlet pipe 120b. In this manner, the first ignition plug and the second ignition plug cause combustion in the inner space 130 of the rotor housing 100. Here, the first inlet pipe 110a and the second inlet pipe 110b correspond to an intake configuration through which air required for combustion is introduced, and the first outlet pipe 120a and the second outlet pipe 120b correspond to an exhaust configuration through which the combusted air is discharged to the outside.

The reason why the total number of inlet pipes 110 and outlet pipes 120 is four as described above is that, since the reciprocating rotor is rotated within the rotor housing 100 and a stroke of the reciprocating rotor is changed depending on the rotation angle of the reciprocating rotor, a plurality of the inlet pipes 110 and outlet pipes 120 is installed in the rotor housing so as to ensure a smooth four-stroke cycle, thereby making it possible not only to more precisely control the timing of intake and exhaust, but also to ensure that there is no problem with fuel supply and exhaust gas emission.

In order to control the above-described intake and exhaust, a first inlet valve 160a and a second inlet valve 160b are respectively installed in the first inlet pipe 110a and the second inlet pipe 110b so as to perform intake control, and a first outlet valve 170a and a second outlet valve 170b are respectively installed in the first outlet pipe 120a and the second outlet pipe 120b so as to perform exhaust control.

As shown in the drawing, when the reciprocating rotor 300 is in the horizontal state, the second inlet pipe 110b and the second outlet pipe 120b are preferably formed at a higher position than a position of the reciprocating rotor 300.

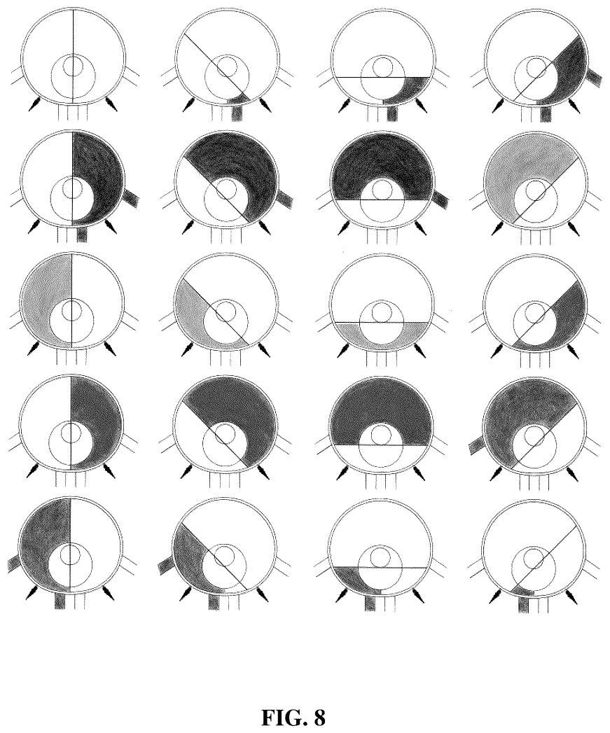

FIG. 8 is a view sequentially showing changes in stroke operation of the sine rotary engine applied to the internal combustion engine, in which blue represents an intake stroke, yellow represents a compression stroke, red represents an expansion stroke, and gray represents an exhaust stroke.

As shown in FIG. 8, referring to a process of the four-stroke cycle performed in the rotor housing 100, in the case of an internal combustion engine-type sine rotary engine, in one cycle, the reciprocating rotor 300 and the power shaft 200 are rotated 720 degrees, and the eccentric shaft 400 is rotated 1440 degrees. When the reciprocating rotor 300 is rotated such that the inlet valve 160a is opened, a mixture (of fuel and air) is continuously introduced into the rotor housing through an inlet port until the reciprocating rotor 300 is rotated 180 degrees so as to be placed in the horizontal state in the rotor housing. In this case, when the reciprocating rotor is placed in the horizontal state in which the central portion of the reciprocating rotor coincides with the central portion of the power shaft 200, the volume of the mixture (of fuel and air) in the rotor housing becomes maximum, and the process moves from the intake stroke to the compression stroke. When the reciprocating rotor is rotated 180 degrees so as to be placed in the horizontal state again, the mixture that has started to be compressed has the highest compression ratio, and explosion of the mixture occurs. Expansion caused by the explosion continuously occurs until the reciprocating rotor is further rotated 180 degrees to reach the horizontal state thereof. At this moment, the volume of the exploded mixture in the rotor housing becomes maximum. Thereafter, the reciprocating rotor is rotated with the power shaft 200 and discharges generated exhaust gas through an exhaust port.

In this manner, when the sine rotary engine according to the present invention is applied to the internal combustion engine, high torque may be obtained with excellent energy efficiency, and a two-stroke cycle is performed in one rotor housing 100. Therefore, when two or more sine rotary engines are arranged so as to simultaneously perform four or more strokes, it is possible not only to implement an efficient structure but also to achieve weight reduction compared to other engines of the related art. Further, the power shaft 200 is directly rotated based on eccentric circular motion without using a connecting rod and a crankshaft of the related art, thereby having an effect of solving torque imbalance.

FIG. 9 is a view showing a structure in which the outer circumferential surface of the power shaft 200 of the present invention is transformed into a gear shape such that rotational power generated from the power shaft 200 is output as power of the power shaft in the form of a gear engagement mechanism. In this manner, rotational power of the power shaft 200 may be output to the outside in various forms, and the form may vary depending on the purpose of the present invention.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sine rotary engine comprising:
a rotor housing (100) having an inlet pipe (110) and an outlet pipe (120) respectively formed therein, the rotor housing having an inner space (130) formed with a curved inner surface of the rotor housing and configured to allow fluid introduced through the inlet pipe (110) to fill the inner space;
a power shaft (200) rotatably installed inside the rotor housing (100), the power shaft being installed at a position eccentric from a central point of the inner space (130);
a reciprocating rotor (300) formed corresponding to a width of the inner space (130) of the rotor housing (100) and installed through a central portion of the power shaft (200) in a radial direction of the power shaft, wherein the reciprocating rotor is rotated inside the rotor housing (100) while performing linear reciprocating motion in the radial direction of the power shaft (200) according to a rotation angle thereof; and
an eccentric shaft (400) formed to have a smaller diameter than a diameter of the power shaft (200) and rotatably installed in the rotor housing (100), wherein the eccentric shaft is connected to a central portion of the reciprocating rotor (300) and guides the reciprocating rotor (300) such that the reciprocating rotor has a constant rotational orbit, wherein:
the rotor housing (100) has bearings installed therein, wherein the bearings are respectively installed in portions of the rotor housing, the portions allowing the power shaft (200) and the eccentric shaft (400) to be respectively installed therein, and wherein, for smooth rotational motion, a first bearing (500) is installed in the portion of the rotor housing, the portion allowing the power shaft (200) to be installed therein, and a second bearing (600) is installed in the portion of the rotor housing, the portion allowing the eccentric shaft (400) to be installed therein,
the eccentric shaft (400) is installed in the rotor housing such that a central point of the eccentric shaft is located above a central point of the power shaft (200),
the reciprocating rotor (300) has a first pin hole (310) formed in the central portion thereof, and the eccentric shaft (400) has a second pin hole (410) formed in a position eccentric from a central portion of the eccentric shaft, wherein the reciprocating rotor and the eccentric shaft are axially coupled to each other by a guide pin (420) inserted into the first pin hole (310) and the second pin hole (410),
an internal shape of the rotor housing (100) is determined by a ratio of a length of the reciprocating rotor (300) to the diameter of the eccentric shaft (400), and the rotor housing is determined by an equation of sin(θ)+k or α cos(θ)+k, and
in the equation, α represents the diameter of the eccentric shaft (400) (eccentric circle), k represents half of the length of the reciprocating rotor (300), 2k is equal to the length of the reciprocating rotor (300), and θ is an angle from 0 to 2π, wherein the θ corresponds to an angular range for traces of points drawn around an origin according to a value of a polar coordinate equation.

2. The sine rotary engine according to claim 1, wherein:
the power shaft (200) is installed at a lower portion of a center of the rotor housing (100), and
the inlet pipe (110) and the outlet pipe (120) are respectively formed on a left side of the power shaft (200) and a right side thereof.

3. The sine rotary engine according to claim 1, wherein the inlet pipe (110) is formed to be smaller than the outlet pipe (120).

4. The sine rotary engine according to claim 1, wherein:
the inlet pipe (110) is formed of a plurality of inlet pipes comprising a first inlet pipe (110a) and a second inlet pipe (110b), and
the outlet pipe (120) is formed of a plurality of outlet pipes comprising a first outlet pipe (120a) and a second outlet pipe (120b).

5. The sine rotary engine according to claim 4, wherein:
the rotor housing (100) has a first ignition plug (140) and a second ignition plug (150) installed therein, the first ignition plug being disposed between the first inlet pipe (110a) and the second inlet pipe (110b), the second ignition plug being disposed between the first outlet pipe (120a) and the second outlet pipe (120b), and
the first ignition plug and the second ignition plug cause combustion in the inner space (130) of the rotor housing (100).
